(19) United States
(12) Patent Application Publication
(10) Pub. No.: US 2009/0052999 A1
(43) Pub. Date: Feb. 26, 2009

(54) CUTTING INSERT AND METHOD

(75) Inventor: Roger D. Phillips, II, Rock Hill, SC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: AGGRESSIVE EQUIPMENT, INC., Rock Hill, SC (US)

(21) Appl. No.: 11/844,814

(22) Filed: Aug. 24, 2007

(51) Int. Cl. B26D 1/00

(52) U.S. Cl. 407/102

(57) ABSTRACT

An indexable cutting insert for beveling a pipe end, and having a first quadrilateral surface and a second quadrilateral surface in spaced, generally parallel relationship to each other separated by a non-parallel planar sidewall comprised of four side flank portions defined as a portion of the sidewall extending from one corner of the insert to an adjacent corner of the insert. The non-parallel sidewall and both the first and second surfaces define intersecting cutting edges. A related method is also disclosed.

### TECHNICAL FIELD AND BACKGROUND OF THE INVENTION

This disclosure relates to an indexable cutting insert for a tool holder, and more specifically, an indexable cutting insert used with a tool holder for a pipe beveling machine. The insert is formed of a hard metal material having first and second parallel surfaces shaped generally as parallelograms joined by four planar cutting edges forming perimeter sidewalls of the insert. The cutting edges meet at oppositely disposed acute corners forming 27 degree angles. The insert is removably mounted in a tool holder, and, according to the particular embodiment disclosed in this application, is used in conjunction with a split frame to bevel a pipe along a line perpendicular to the longitudinal axis of the pipe as the cutting insert and associated elements are rotated by a pneumatic or hydraulic motor. This procedure is frequently carried out as a part of a method of removing damaged or worn sections of pipe from a longer length of pipe in preparation for welding a replacement section of pipe onto the remaining length. Various industry standards require that a section of pipe be removed and beveled in a specified manner in order to provide a suitable shape that can be mated and welded to a new section of pipe.

When cutting pipes having a wall thickness of less that ¾ inch, the cutting insert can be used to form a single 37 degree bevel onto the end of the pipe. When beveling a pipe with a wall thickness of greater than ¾ inch, the cutting insert will form a bevel that has an initial 10 degree taper and then an inner 37 degree taper, in a single step. The insert is offset 10 degrees in order to produce a 37 degree angle bevel from the 27 degree angle on the cutting insert.

One present method of severing pipe involves the use of a tool steel cutter having integrally-formed ground edges rather than using a cutter that includes an insert. Other prior art cutting inserts present difficulties when the particular purpose is beveling pipe sections. In particular, such inserts are symmetrical front to back, and when the cutting edge is worn, the insert is flipped front to back. The symmetrical shape of the cutting insert makes it difficult to secure it to the tool holder in such a manner as to maintain it immobile and in the exact required position.

### SUMMARY OF THE INVENTION

Therefore, it is an object of the invention to provide a cutting insert for a tool holder that is adapted for being securely held in the tool holder in an exact cutting position.

It is another object of the invention to provide a cutting insert for a tool holder that permits the cutting insert to bevel a pipe where the bevel forms two adjacent angles, such as an initial 10 degree taper and then an inner 37 degree taper, in a single cutting step.

These and objects and advantages of the invention are achieved by providing an indexable cutting insert, comprising a first quadrilateral surface and a second quadrilateral surface in spaced, generally parallel relationship to each other, and separated by a non-parallel planar sidewall comprised of four side flank portions defined as a portion of the sidewall extending from one corner of the insert to an adjacent corner of the insert. The non-parallel sidewall and both the first and second surfaces define intersecting cutting edges.

According to another embodiment of the invention, a clamp is provided for mounting the cutting insert to a tool holder, the clamp having a mounting face with an angle complementary to an adjacent sidewall portion and defining an overhang for retaining the cutting insert against the tool holder.

According to another embodiment of the invention, the angle of the mounting face of the clamp and the angle of the sidewall of the cutting insert is 83 degrees with reference to the first and second quadrilateral surfaces.

According to another embodiment of the invention, two adjacent side flank portions define an acute angle in relation to each other.

According to another embodiment of the invention, two adjacent side flank portions define an angle of 27 degrees in relation to each other.

According to another embodiment of the invention, an indexable cutting insert is adapted for being mounted by a clamp to a tool holder, the clamp having a mounting face with an angle complementary to an adjacent sidewall portion and defining an overhang for retaining the cutting insert against the tool holder.

According to another embodiment of the invention, a clamp is provided for mounting the cutting insert to a tool holder, the clamp having a mounting face with an angle complementary to an adjacent sidewall portion and defining an overhang for retaining the cutting insert against the tool holder.

According to a method embodiment of the invention, a method of beveling a pipe end is provided, comprising the steps of providing an indexable cutting insert. The indexable cutting insert includes a first quadrilateral surface and a second quadrilateral surface in spaced, generally parallel relationship to each other, and separated by a non-parallel planar sidewall comprised of four side flank portions defined as a portion of the sidewall extending from one corner of the insert to an adjacent corner of the insert. The non-parallel sidewall and both the first and second surfaces define intersecting cutting edges. The method further includes the steps of mounting the cutting insert in a tool holder, positioning the tool holder in proximity to the pipe, causing relative rotation of the tool holder and pipe, and indexing the cutting insert and tool holder during relative rotation of the tool holder and pipe to thereby form an annular bevel on the pipe end.

According to another embodiment of the invention, the method includes the step of providing a clamp for mounting the cutting insert to a tool holder, the clamp having a mounting face with an angle complementary to an adjacent sidewall portion and defining an overhang for retaining the cutting insert against the tool holder.

According to another embodiment of the invention, the method includes the step of mounting the cutting insert by a clamp to a tool holder, the clamp having a mounting face with an angle complementary to an adjacent sidewall portion and defining an overhang for retaining the cutting insert against the tool holder.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a side elevation of a prior art cutting insert and tool holder.

FIG. 2 is a perspective view of a cutting insert according to an embodiment of the invention;

FIG. 3 is an elevation of the rear-facing side of the cutting insert of FIG. 2;

FIG. 4 is a top plan view of the cutting insert shown in FIG. 2;

FIGS. 5 and 6 are side elevations of opposite sides of the cutting insert shown in FIG. 2;

FIG. 7 is an elevation of the front-facing side of the cutting insert of FIG. 2;

FIG. 8 is a side elevation of a tool holder for the insert shown in FIGS. 2-7;

FIG. 9 is an end view showing the overhang angle of the tool holder clamp;

FIG. 10 is an enlarged, fragmentary view according to FIG. 8, and including angles according to one preferred embodiment of the invention;

FIG. 11 is a perspective view of the tool holder shown in FIG. 8;

FIGS. 12, 13 and 14 are perspective, front elevation and end elevation views of the cutting insert clamp;

FIGS. 15 and 16 are exploded perspective views showing the positioning of the cutting insert and clamp onto the tool holder;

FIG. 17 is a perspective view of the cutting insert mounted in a tool holder;

FIG. 18 is a perspective view of the cutting insert mounted in a tool holder from the reverse viewpoint of FIG. 17; and

FIG. 19 is a perspective view of a split frame carrying the tool holder and cutting insert during a pipe beveling procedure.

### DESCRIPTION OF THE PREFERRED EMBODIMENTS AND BEST MODE

Referring specifically to the drawings, a cutting insert 1 according to a prior art embodiment is shown mounted in a conventional tool holder 2. In general, the cutting insert 1 is symmetrical from side-to-side, end-to-end and top-to-bottom with perpendicular sidewalls. The insert 1 is turned front to back when the cutting edge is worn, to make use of the opposite end of the insert 1.

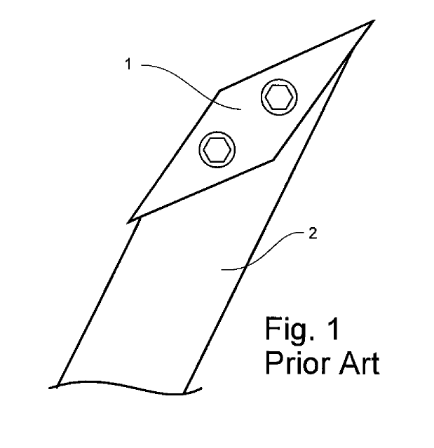

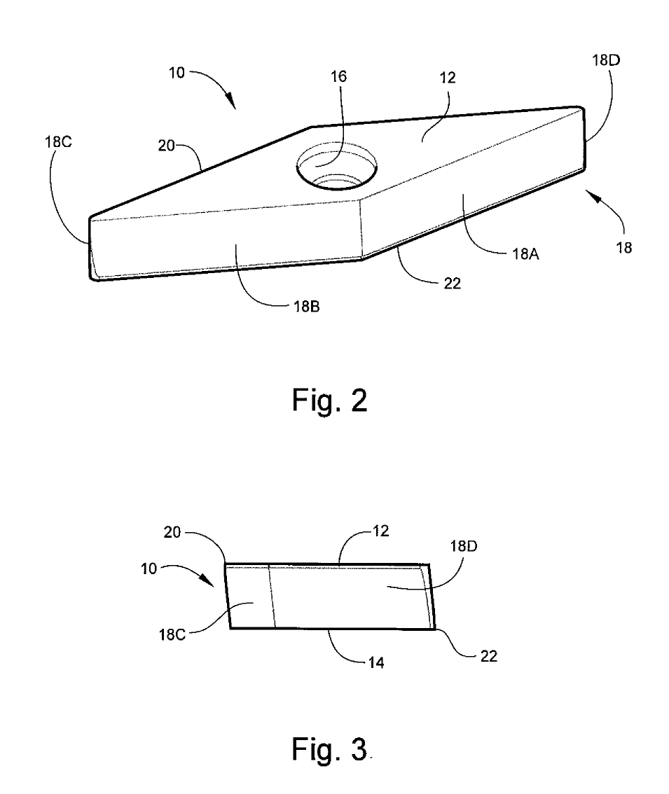

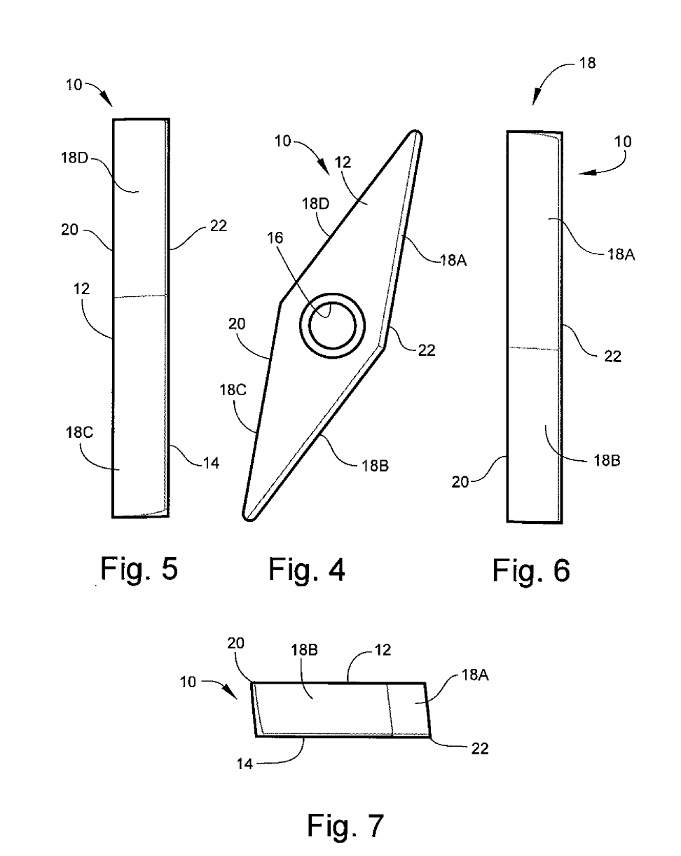

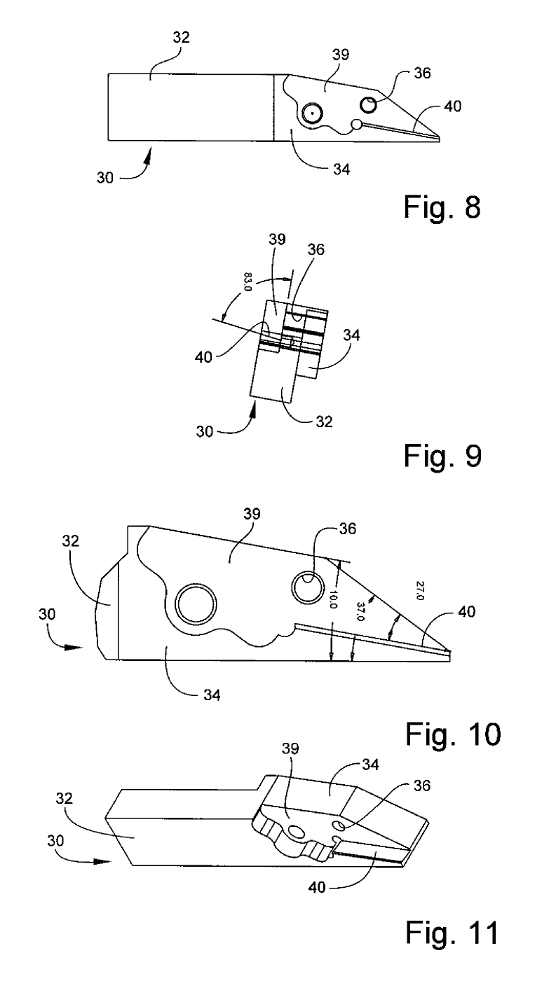

Referring now to FIGS. 2-7, a cutting insert according to the present invention is shown generally in FIG. 1 at reference numeral 10. Cutting insert 10 includes first and second quadrilateral surfaces 12 and 14 with a mounting hole 16 for mounting the cutting insert 10 to a tool holder, for example, such as shown in FIGS. 8-19. The first and second quadrilateral surfaces 12, 14 are in spaced, generally parallel relationship to each other, and are separated by a non-parallel planar sidewall 18 comprised of four side flank portions 18A-D, defined as a portion of the sidewall 18 extending from one corner of the insert 10 to an adjacent corner of the insert 10. As discussed in further detail below, the sidewall 18 and both the first and second surfaces 12, 14 define respective intersecting cutting edges 20, 22.

As is most clearly shown in FIGS. 3 and 7, the sidewall 18 is not perpendicular to the first and second surfaces 12 and 14, but instead forms an angle, for example, 83 degrees, with a complementary angle of 7 degrees from the perpendicular. According to the particular embodiment disclosed in this application, the respective pairs of adjacent side flank portions 18A, 18D and 18B, 18C define acute angles in relation to each other, for example, angles of 27 degrees. These 27 degree angles facilitate use of the cutting insert 10 in the proper beveling of pipe ends when one pipe section is being removed from a length of pipe in the manner described above. The cutting insert 10 is fabricated of conventional hard metal materials suitable for use in beveling steel pipe, and the particular material used is not germane to the invention claimed in this application.

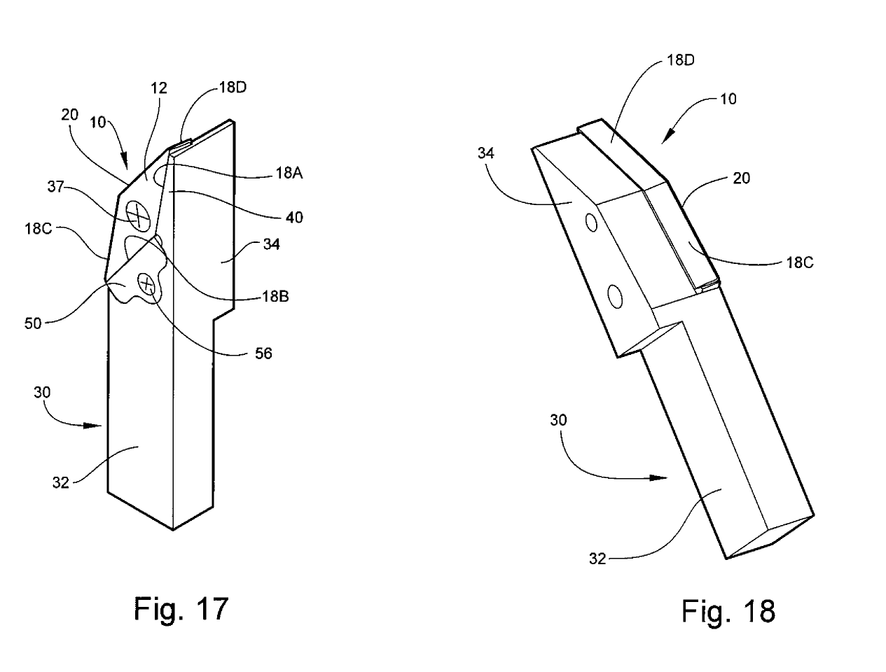

Referring now to FIGS. 8-11, a tool holder 30 for receiving the cutting insert 10 is shown. The tool holder 30 includes a mounting shank 32 and a mounting head 34 with a mounting hole 36 that is aligned with the mounting hole 16 in the cutting insert 10 for receiving a mounting screw 37 therethrough, as shown in FIGS. 17 and 18. The mounting head also includes a clamp mounting hole 38. The mounting head 34 is provided with a recess 39 to receive the cutting insert 10.

As is shown in FIGS. 10 and 11, the mounting head 34 is provided with angles specifically adapted for the pipe-beveling use described herein, and include a 37 degree angle and a 10 degree offset, resulting in the same 27 degree angle that the respective pairs of adjacent side flank portions 18A, 18D and 18B, 18C define in relation to each other. The mounting head 34 also includes an angled support wall 40 that is provided with an 83 degree angle that mates with the angle of the sidewall 18 of the cutting insert 10. The inward angle of the support wall 40 provides an “overhang” and thus a mechanical inference against movement of the cutting insert 10 away from its position on the mounting head 34.

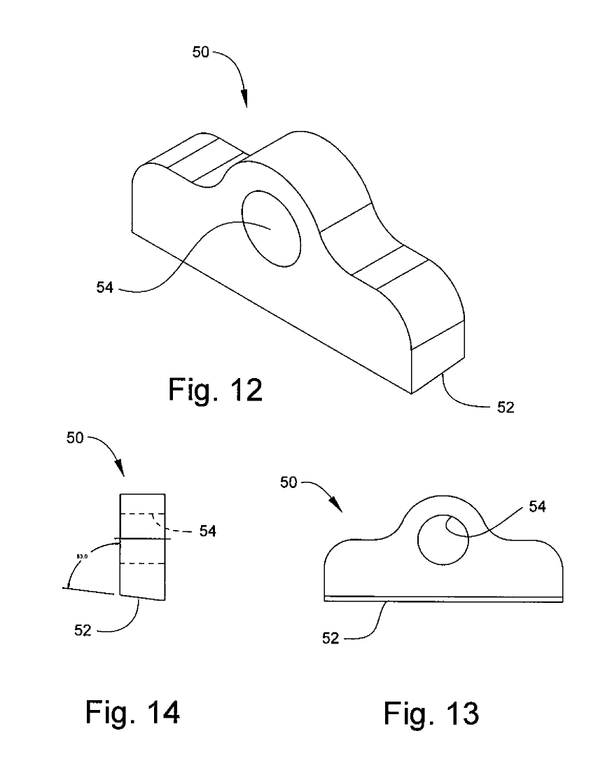

Referring now to FIGS. 12-14, the cutting insert 10 is held in place on the mounting head 34 by a clamp 50 that is shaped to mate with and fit into the curved shape of the recess 39 of the mounting head 34. The clamp 50 has a clamping face 52 with an 83 degree angle that mates with the adjacent side flank portion 18A-18D of the cutting insert 10, and a mounting hole 54. The clamping face 52 and the support wall 40 of the mounting head 34 provide a clamping support for one entire side of the cutting insert 10 that both hold the cutting insert 10 at the required 10 degree offset and restrain movement of the cutting insert 10 away from its proper position in the mounting head 34. As positioned, complementary 83/7 degree angles are formed when the cutting insert 10 is positioned against the clamping face 52 of the clamp 50 and the support wall 40 of the mounting head 34.

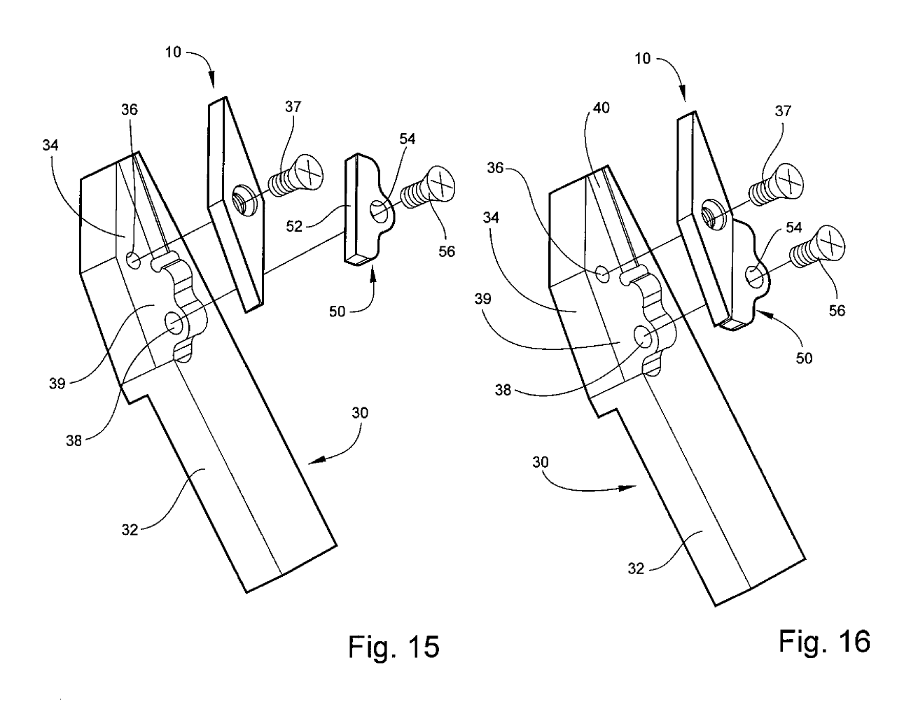

As shown in FIGS. 15-18, the cutting insert 10 is mounted onto the mounting head 34 by placing the cutting insert 10 onto the mounting head 34 with one adjacent side flank portion, for example 18A, against the support wall 40. The clamp 50 is then positioned in place, with the clamping face 52 against the adjacent side flank portion 18B, as shown. The cutting insert 10 is secured to the mounting head 34 by a mounting screw 37 and the clamp 50 is mounted to the mounting head 34 by a mounting screw 56.

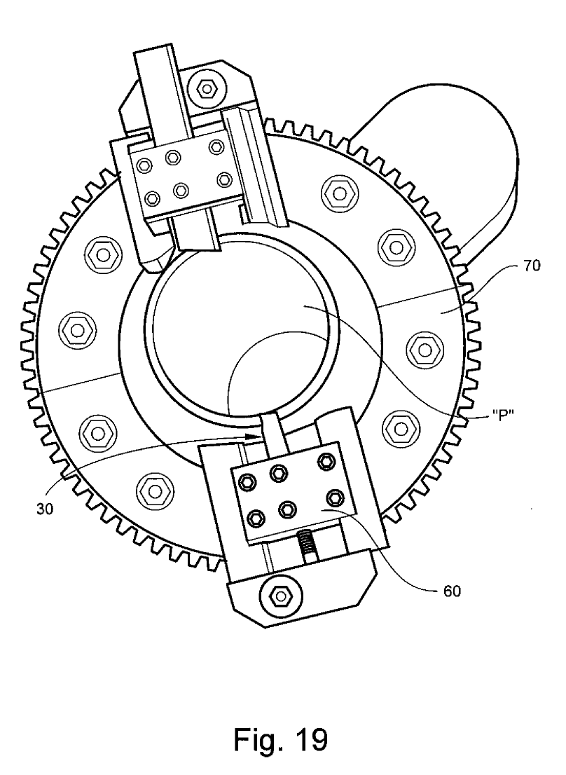

Referring now to FIG. 19, the tool holder 30 is then secured into an indexing apparatus 60 that is part of a split frame apparatus 70, and the pipe-beveling operation on pipe “P” is commenced. At some point, the exposed cutting edge 20 becomes worn. The cutting insert 10 is removed from the mounting head 34. In contrast to prior art cutting inserts, the cutting insert 10 is not turned front to back. This would create a mismatch between the angle of the adjacent side flanks of the sidewall 18 and the angle of the support wall 40 and clamping face 52. Instead, the cutting insert 10 is flipped over top-to-bottom and reattached to the mounting head 34. This provides the proper angle between the angle of the adjacent side flanks of the sidewall 18 and the angle of the support wall 40 and clamping face 52.

An improved cutting insert is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

We claim:

1. An indexable cutting insert, comprising:
(a) a first quadrilateral surface and a second quadrilateral surface in spaced, generally parallel relationship to each other, and separated by a non-parallel planar sidewall comprised of four side flank portions defined as a portion of the sidewall extending from one corner of the insert to an adjacent corner of the insert; and
(b) the non-parallel sidewall and both the first and second surfaces defining intersecting cutting edges.

2. An indexable cutting insert according to claim 1, and including a clamp for mounting the cutting insert to a tool holder, the clamp having a mounting face with an angle complementary to an adjacent sidewall portion and defining an overhang for retaining the cutting insert against the tool holder.

3. An indexable cutting insert according to claim 2, wherein the angle of the mounting face of the clamp and the angle of the sidewall of the cutting insert is 83 degrees with reference to the first and second quadrilateral surfaces.

4. An indexable cutting insert according to claim 1, wherein two adjacent side flank portions define an acute angle in relation to each other.

5. An indexable cutting insert according to claim 1, wherein two adjacent side flank portions define an angle of 27 degrees in relation to each other.

6. An indexable cutting insert according to claim 1, and adapted for being mounted by a clamp to a tool holder, the clamp having a mounting face with an angle complementary to an adjacent sidewall portion and defining an overhang for retaining the cutting insert against the tool holder.

7. An indexable cutting insert according to claim 1, and including a clamp for mounting the cutting insert to a tool holder, the clamp having a mounting face with an angle complementary to an adjacent sidewall portion and defining an overhang for retaining the cutting insert against the tool holder.

8. A method of beveling a pipe end, comprising the steps of:
(a) providing an indexable cutting insert, comprising:
(i) a first quadrilateral surface and a second quadrilateral surface in spaced, generally parallel relationship to each other, and separated by a non-parallel planar sidewall comprised of four side flank portions defined as a portion of the sidewall extending from one corner of the insert to an adjacent corner of the insert; and
(ii) the non-parallel sidewall and both the first and second surfaces defining intersecting cutting edges;
(b) mounting the cutting insert in a tool holder;
(c) positioning the tool holder in proximity to the pipe;
(d) causing relative rotation of the tool holder and pipe;
(e) indexing the cutting insert and tool holder during relative rotation of the tool holder and pipe to thereby form an annular bevel in the pipe.

9. A method according to claim 8, and including the step of providing a clamp for mounting the cutting insert to a tool holder, the clamp having a mounting face with an angle complementary to an adjacent sidewall portion and defining an overhang for retaining the cutting insert against the tool holder.

10. A method according to claim 9, wherein the angle of the mounting face of the clamp and the angle of the sidewall of the cutting insert is 83 degrees with reference to the first and second quadrilateral surfaces.

11. A method according to claim 8, wherein two adjacent side flank portions define an acute angle in relation to each other.

12. A method according to claim 8, wherein two adjacent side flank portions define an angle of 27 degrees in relation to each other.

13. A method according to claim 8, and including the step of mounting the cutting insert by a clamp to a tool holder, the clamp having a mounting face with an angle complementary to an adjacent sidewall portion and defining an overhang for retaining the cutting insert against the tool holder.

14. An indexable cutting insert according to claim 1, and including a clamp for mounting the cutting insert to a tool holder, the clamp having a mounting face with an angle complementary to an adjacent sidewall portion and defining an overhang for retaining the cutting insert against the tool holder.
